(19) United States
(12) Patent Application Publication
(10) Pub. No.: US 2005/0180305 A1
(43) Pub. Date: Aug. 18, 2005

(54) Optical recording medium

(75) Inventors: Chiaki Yokota, Sodergaura-shi, Chiba (JP); Satoru Suda, Sodegaura-shi, Chiba (JP); Masatoshi Yanagimachi, Tokyo (JP)

Correspondence Address: BURNS DOANE SWECKER & MATHIS L L P, POST OFFICE BOX 1404, ALEXANDRIA, VA, 22313-1404, US

(73) Assignee: MITSUI CHEMICALS , INC, Tokyo (JP)

(21) Appl. No.: 10/493,871

(22) PCT Filed: Nov. 8, 2002
(86) PCT No.: PCT/JP02/11690

(30) Foreign Application Priority Data
Nov. 8, 2001 (JP) 2001-343242

(51) Int. Cl. G11B 7/24

(52) U.S. Cl. 369/275.4; 369/288

(57) ABSTRACT

There is disclosed an optical recording medium including a recording layer, one or more intermediate layers, and a printable or typable surface protective layer disposed in this order on a transparent substrate having an annular plate shape, the optical recording medium having an inner peripheral portion in which the recording layer is not formed on an inner peripheral side in a radial direction of the transparent substrate, wherein the surface protective layer is formed in at least a part of the inner peripheral portion, and a hydrophobic intermediate layer is directly formed on the transparent substrate in a region of the inner peripheral portion in which the surface protective layer is formed. Label information can be formed on the optical recording medium even in an innermost peripheral hub portion by printing or the like.

### TECHNICAL FIELD

The present invention relates to an optical recording medium, particularly to an optical recording medium whose surface is writable with writing materials, an ink jet printer or a thermal transfer type printer.

### BACKGROUND ART

For read-only type optical recording mediums which have generally spread at present, such as a compact disk (CD) and a laser disk (LD), a substrate having information is manufactured from a master usually called a stamper by an injection molding method. In this method, it is possible to manufacture a large amount of mediums having the same information inexpensively, but the stamper is very expensive, and therefore the method is not suitable for preparing a small amount of mediums. Moreover, with progress of the information society in recent years, there has been an earnest demand for higher-density recording than a magnetic recording medium. Then, an optical recording medium for recording/storing data at disposal by a user has been developed in order to prepare a small amount of mediums.

The optical recording mediums are classified into two types: a write-once type capable of recording and reading information; and a rewritable type capable of deleting data after recorded. Among them, a write-once type compact disk having a single plate structure is called CD-R, and since the disk has compatibility with a usual read-only CD, the number of users has suddenly increased. Also in recent years, since a higher-density recordable DVD-R also has compatibility with the CD-R, an increase in demand has been largely expected. For the CD-R and DVD-R, a medium in which the data is not stored is purchased, and subsequently each user writes various information or data peculiar to the user in the medium for use. Therefore, the medium is preferably devised in such a manner that the user can recognize the recorded information at a glance in a certain method.

In general, in a method of indicating label information such as a title and a design for the written information on the optical recording medium, the information is directly printed on a disk surface by an ink jet printer or a thermal transfer printer. In recent years, there has been a further strong demand for beautiful appearance with the developments of various high-precision printers.

To satisfy these demands, the present inventors have made attempts to coat the whole surface of the optical recording medium on the side opposite to a light incidence surface with a hydrophilic coating layer printable with the ink jet printer or thermal transfer printer.

For these coating layers, at present, a large number of applications have been filed such as Japanese Patent Application Laid-Open Nos. 6-060432 (1994), 8-102088 (1996), 8-102087 (1996), 8-102090 (1996), 7-044888 (1995) and 7-169100 (1995).

### DISCLOSURE OF THE INVENTION

In order to further pursue beautiful appearance, the present inventors have tried to fix a printable surface protective layer writable directly with an oil-based or water-based pen, or with various ink jet printers or thermal transfer printers, including a hub portion, and have found that compatibility, adhesion and/or wettability between the printable surface protective layer and polycarbonate which is broadly used for a substrate of an optical recording medium are remarkably bad and that ink for forming the surface protective layer is repelled and that it is difficult to directly and uniformly coat the polycarbonate substrate surface. Further problem has been that the hydrophilic surface protective layer has caused a large drop in adhesion in the hub portion. The surface protective layer of the hub portion sometimes peels with an elapse of time.

An object of the present invention is to solve these problems and to provide an optical recording medium in which label information can be formed even on the hub portion in an innermost periphery by printing or the like. Another object of the present invention is to provide an optical recording medium including a surface protective layer which does not peel and which extends to the hub portion.

As a result of intensive researches, the present inventors have made attempts to dispose one layer of various resins having remarkably satisfactory adhesion to a polycarbonate substrate as an underlayer of the printable surface protective layer in order to enhance the compatibility, adhesion and wettability between the polycarbonate substrate and the printable protective layer. Above all, the present inventors have found that an acrylic UV cure resin which does not contain any hydrophilic polymer and which is held between the substrate and the surface protective layer largely contributes to the adhesion. The present inventors have also found that the repelling of ink or the peeling by changes with an elapse of time are suppressed with the enhancement of the adhesion, and thus have achieved the present invention.

According to the present invention, there is provided an optical recording medium comprising a recording layer, one or more intermediate layers, and a printable or typable surface protective layer disposed in this order on a transparent substrate having an annular plate shape,
said optical recording medium having an inner peripheral portion in which the recording layer is not formed on an inner peripheral side in a radial direction of the transparent substrate,
wherein the surface protective layer is formed in at least a part of the inner peripheral portion, and
a hydrophobic intermediate layer is directly formed on the transparent substrate in a region of the inner peripheral portion on which the surface protective layer is formed.

In the optical recording medium, there may be a mode such that a protrusion or a groove concentric to the transparent substrate is formed on the transparent substrate, a recording region in which the recording layer and the surface protective layer are formed is disposed on an outer peripheral side from the protrusion or the groove, and
the recording layer is not formed and the surface protective layer is formed on an inner peripheral side from the protrusion or the groove.

According to the present invention, there is provided an optical recording medium comprising a recording layer, a second transparent substrate having an annular plate shape, one or more intermediate layers, and a printable or typable surface protective layer disposed in this order on a first transparent substrate having an annular plate shape,
said optical recording medium having an inner peripheral portion in which the recording layer is not formed on an inner peripheral side in a radial direction of the second transparent substrate,
wherein the surface protective layer is formed in at least a part of the inner peripheral portion, and
a hydrophobic intermediate layer is directly formed on the transparent substrate in a region of the inner peripheral portion in which the surface protective layer is formed.

In the optical recording medium, there may be a mode such that a protrusion or a groove concentric to the second transparent substrate is formed on the second transparent substrate, a recording region in which the recording layer and the surface protective layer are formed is disposed on an outer peripheral side from the protrusion or the groove, and
the recording layer is not formed and the surface protective layer is formed on the inner peripheral side from the protrusion or the groove.

The hydrophobic intermediate layer is preferably formed of an acrylic UV cure resin which does not contain a hydrophilic polymer.

A scratch strength in the region of the inner peripheral portion in which the surface protective layer is formed is preferably 55 g or more.

The hydrophobic intermediate layer is preferably formed by silk screen printing.

The surface on which the surface protective layer is formed in the inner peripheral portion is preferably aligned with the surface on which the surface protective layer is formed on an outer peripheral side from the inner peripheral portion by the hydrophobic intermediate layer present in a region of the inner peripheral portion in which the surface protective layer is formed.

In the present invention, “printable or typable” indicates that the writing by any writing material or the printing with any printer such as an ink jet printer or a thermal transfer type printer is possible.

The hub portion indicates a whole region on the inner peripheral side from an annular convex or concave portion (commonly known as a stack ring) having a height or depth of 10 μm or more and 400 μm or less, formed between the recording region and a central hole in a substrate surface. This convex or concave portion is formed by a mold retaining ring at a time of molding a substrate.

The intermediate layer is a resin protective layer excluding a recording layer and a reflective layer, optical interference layer, and second substrate disposed as required, disposed between the substrate and the surface protective layer.

### BRIEF DESCRIPTION OF THE DRAWINGS

FIG. 1 is a schematic sectional view showing a left half of an optical recording medium according to one embodiment of the present invention; and

Each of FIGS. 2 to 8 is schematic sectional views showing another embodiment of the optical recording medium of the present invention.

1: transparent substrate, 2: recording layer, 3: reflective layer, 4: surface protective layer, 5: stack ring, 6: non-recording portion, 7: recording portion, 8: center, 9: hub portion, 10 to 13: intermediate layer, 20: second transparent substrate

### BEST MODE FOR CARRYING OUT THE INVENTION

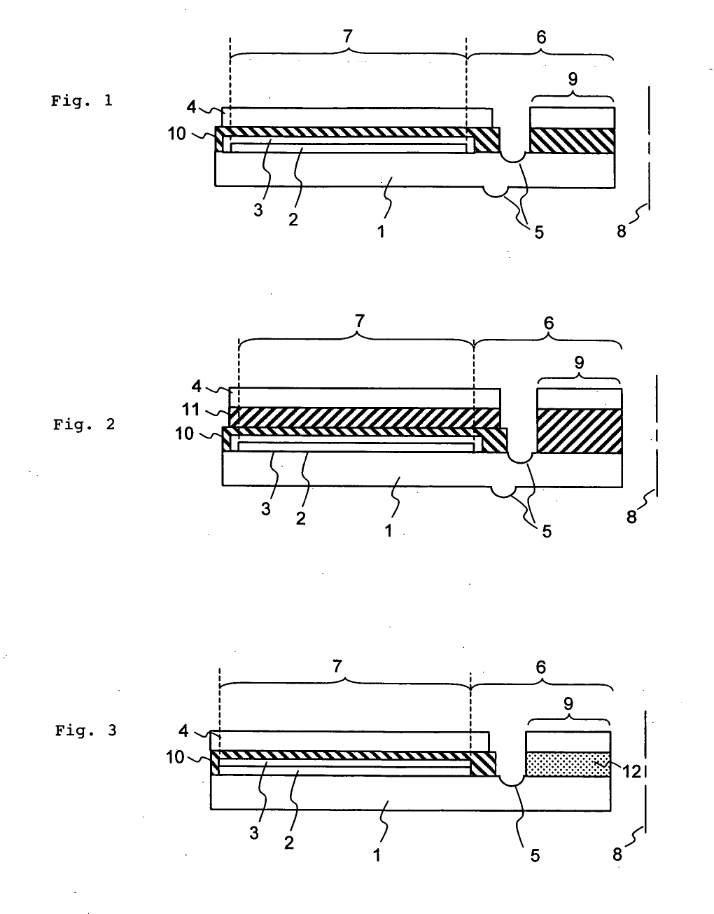

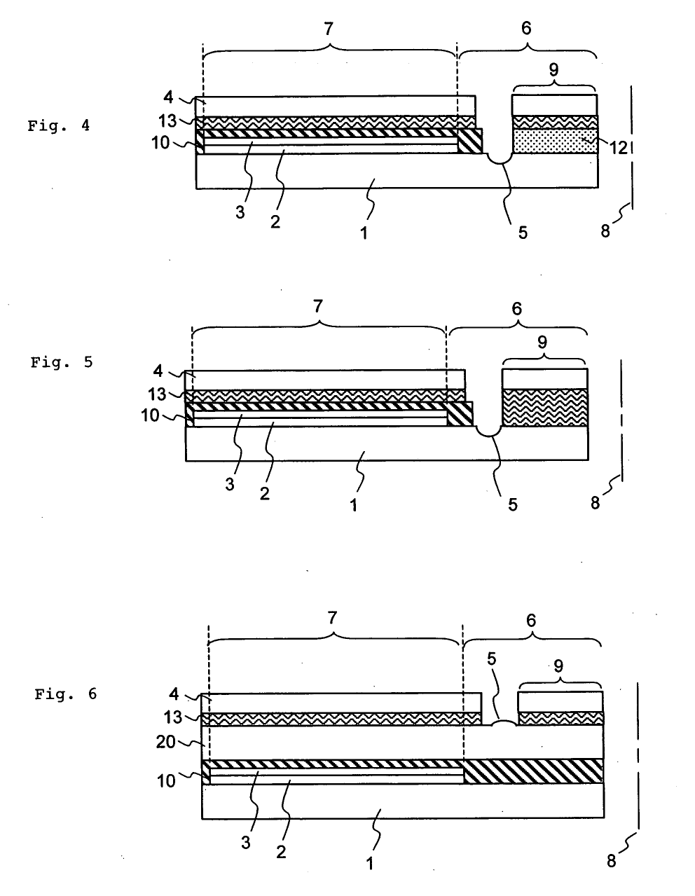

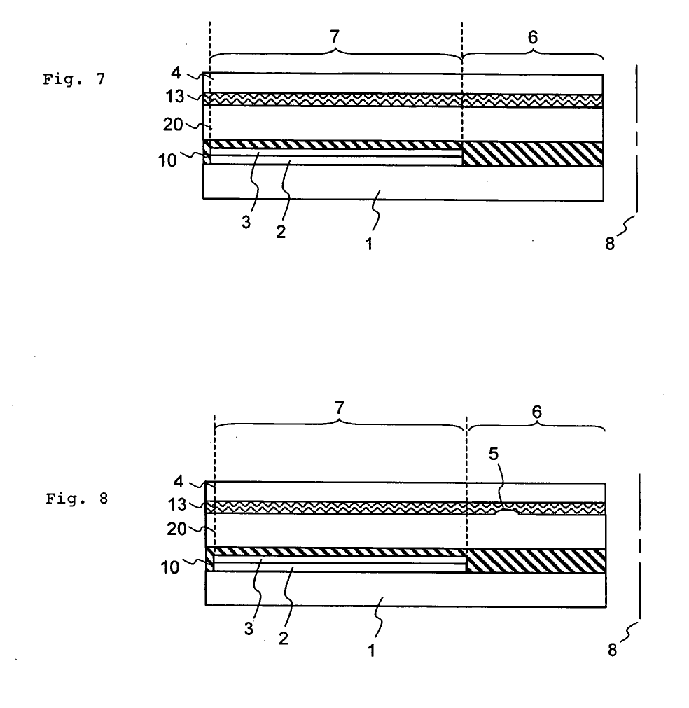

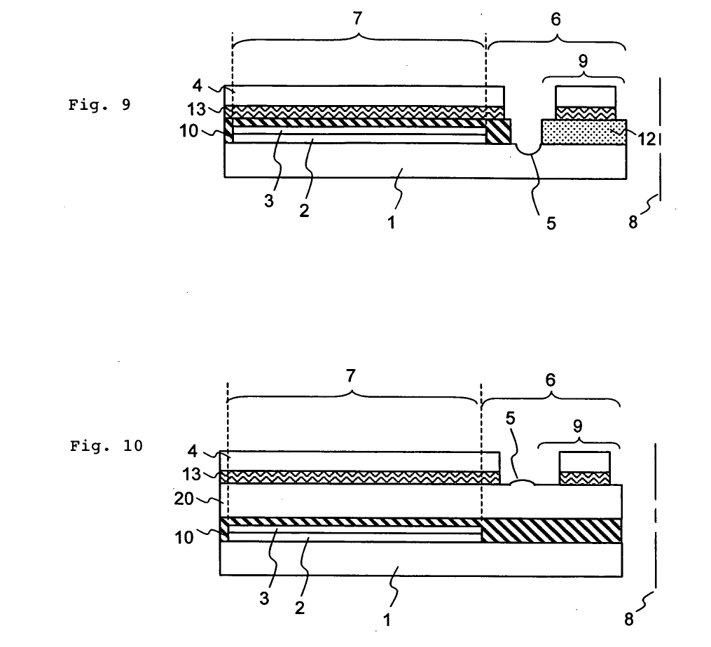

An example of a constitution of an optical recording medium of the present invention is shown in FIG. 1. The optical recording medium consists of a transparent substrate 1 having an annular plate shape, a recording layer 2, a metal reflective layer 3, an intermediate layer 10, and a printable or typable surface protective layer 4. The medium includes an inner peripheral portion 6 in which the recording layer is not formed on an inner peripheral side, and a recording region 7 in which the recording layer is formed on an outer peripheral side from the inner peripheral portion. A protrusion and groove 5 concentric to the transparent substrate, called stack rings, are disposed on the inner peripheral side from the recording region. A portion inside the stack rings is generally referred to as a hub portion 9. A hydrophobic intermediate layer is formed in contact with the transparent substrate, and the surface protective layer is formed on the intermediate layer in the hub portion.

In the mode shown in FIG. 1, there is one intermediate layer. As shown in FIG. 2, another intermediate layer 11 may also be laminated for the purpose such as enhancing characteristics. In the mode shown in FIG. 2, the intermediate layer 11 is disposed in contact with the transparent substrate, and the surface protective layer is disposed on the intermediate layer.

In this manner, the optical recording medium of the present invention may include one or two intermediate layers, or may include three or more intermediate layers. A plurality of intermediate layers may be disposed either in a laminate direction or in a radial direction. In either case, a hydrophobic intermediate layer needs to be formed directly on the transparent substrate in the region of the inner peripheral portion in which the surface protective layer is disposed. It is not necessary that all of the intermediate layers have hydrophobic properties. It is preferred that each intermediate layer is prevented from being peeled by a nail or the like, and that a scratch strength is 55 g or more with a diamond needle. For this purpose, an adhesive layer may be disposed in contact with the intermediate layer as appropriate. On the other hand, the intermediate layer formed at least on the recording layer and reflective layer needs to be hydrophobic so that the intermediate layer largely influences recording characteristics. The hydrophobic intermediate layer does not substantially have a hydrophilic polymer in resin which forms the intermediate layer, nor such a hydrophilic group as a hydrophilic monomer includes, and has a surface property that water or oil droplets are not adsorbed. Concretely, it is possible to judge a hydrophobic/hydrophilic property as follows: the water droplets are dropped on the intermediate layer, and a contact angle is measured by a droplet method after the layer is left to stand at normal temperature (20° C.) for 30 seconds after the dropping. Here, the hydrophobic property means that the contact angle after leaving the layer to stand at normal temperature (20° C.) for 30 seconds after the dropping is 60° or more. The contact angle may be measured using a droplet method contact angle measuring device CA-A, CA-DT or CA-D manufactured by Kyowa Interface Science Co., Ltd.

Any material is usable for the substrate used in the present invention as long as it is transparent because the recording/reading is performed by light. For example, polymeric materials such as a polycarbonate resin, acrylate resin, polystyrene resin, vinyl chloride resin, epoxy resin, polyester resin and amorphous polyolefin, inorganic materials such as glass, and the like are usable. Especially, since high optical transparency and small optical anisotropy are desirable, a polycarbonate-based resin is more preferable. The above polymeric materials inherently have the hydrophobic property, whereas surface hardness is high, and compatibility and wettability with the hydrophilic resin included in the surface protective layer are low under the influences of additives such as a mold release agent contained in the substrate resin.

These substrate surfaces may have a guide groove or pits indicating a recording position, or pits for read-only information in part. These grooves, pits or the like are formed in preparing the substrate by injection molding or casting in a usual method, but may be prepared by a laser cutting method or a photo-polymer method (2P method).

The recording layer for use in the present invention has to be recordable by irradiation with laser light. The recording layer can be classified into layers of an inorganic substance and of an organic substance. Rare earth transition metal alloys such as Tb.Fe.Co and Dy.Fe.Co which perform recording by a photothermal magnetic effect may be used for the inorganic recording layer. Materials containing phase-changing chalcogen-based alloys such as Ge.Te and Ge.Sb.Te may also be used. In the recording layer of the organic substance, an organic dyestuff is mainly used. The dyestuff for use may be a mixture of a plurality of dyestuffs. A substance other than an light-absorbing substance may be added. One or more of a record assist layer, optical interference layer and the like may be disposed under or over the recording layer. A forming range in a radial direction of the recording layer is determined by standards, for example, Orange Book for CD-R, and DVD-R for General for DVD-R.

Concrete examples of the dyestuff for use in the recording layer include a macrocyclic azaannulene-based dyestuff (phthalocyanine dyestuff, naphthalocyanine dyestuff, porphyrin dyestuff, etc.), polymethine-based dyestuff (cyanine dyestuff, merocyanine dyestuff, squarylium dyestuff, etc.), anthraquinone-based dyestuff, azulenium-based dyestuff, azo-based dyestuff, indoaniline-based dyestuff, and the like. For the recording layer containing the above-described dyestuff, it is usually possible to form a film by coating methods such as spin coating, spray coating, dip coating, and roll coating. At this time, the dyestuff and other substances for forming the recording layer may be dissolved in a solvent which does not damage the substrate, applied, and dried. For this purpose, an aliphatic or alicyclic hydrocarbon-based solvent such as hexane, heptane, octane, decane, and cyclohexane; an aromatic hydrocarbon-based solvent such as toluene and xylene; an ether-based solvent such as diethyl ether and dibutyl ether; an alcohol-based solvent such as methanol, ethanol, isopropyl alcohol, and methyl cellosolve; and a polar solvent, e.g., halogenated hydrocarbon such as 1,2-dichloroethane and chloroform may be used. These solvents may be used alone, or mixed.

A vacuum evaporation method may be used as a method of forming the recording layer. This method is effective in a case where the recording layer substance is not easily soluble in the solvent, or where it is impossible to select a solvent that does not damage the substrate. Various underlayers may be disposed between the recording layer and the substrate for the purpose such as preventing the recording layer from being degraded. For example, it is possible to use a layer formed of an organic substance such as polystyrene and polymethyl methacrylate, and an inorganic substance such as SiO₂. These may be used alone or mixed. Two or more types may be laminated and used.

A metal reflective layer may be formed on the above-described recording layer using metals such as Au, Al, Pt, Ag and Ni or alloys of them. Particularly, gold stable in oxygen or moisture is desirably used. For the reflective layer, the film is formed by a evaporation, sputtering or ion plating method. The optical interference layer may be disposed between the metal reflective layer and the recording layer in order to enhance an adhesive force between the layers, or for purposes of raising reflectance and the like. To handle an ecological type, an intermediate layer consisting of a resin layer may be disposed directly on the recording layer without stacking the metal reflective layer. As an air sandwich type, a second substrate including an air gap may be formed on the layer.

An intermediate layer for protecting the underlayer (hereinafter referred to as an underlayer protective layer as the case may be) is preferably disposed on the above-described reflective layer from a viewpoint of recording characteristics. Here, the underlayer protective layer is a layer laminated so that the recording can be performed with appropriate recording characteristics without damaging the recording layer or the reflective layer. The underlayer protective layer needs to be hydrophobic in order to avoid influences of moisture and temperature as much as possible.

As a resin usable for forming the underlayer protective layer, there is a resin which does not contain a hydrophilic polymer, for example, a resin polymerized by a general radical reaction such as acrylate-based and methacrylate-based resin; a resin causing a cationic polymerization by light such as epoxy-based resin; and the like. The resin may be polymerized alone or mixed with a monomer or an oligomer. The resin may be diluted in a solvent and applied. When the underlayer protective layer is formed, a method such as the spin coating, dip coating, bar coating, and screen printing is performed. The underlayer protective layer is formed by the spin coating method in many cases from a viewpoint of workability. The film thickness of the underlayer protective layer may be set to 1 μm to 100 μm, preferably to 1 to 20 μm.

In the mode shown in FIG. 1, an intermediate layer 10 for protecting the underlayers is disposed on the outer peripheral side from the stack ring 5, and in the hub portion 9.

An intermediate layer (hereinafter referred as an intermediate protective layer as the case may be) may also be disposed on the underlayer protective layer to further protect the underlayer protective layer and recording layer. The intermediate protective layer is preferably an intermediate layer formed of an acrylic UV cure resin which does not contain any hydrophilic polymer. The acrylic UV cure resin which does not contain any hydrophilic polymer is defined as a UV cure resin free from any homopolymer and copolymer including a hydrophilic group, such as polyvinyl alcohol, hydroxyethyl cellulose, hydroxypropyl cellulose, polyacrylamido, polyvinyl pyrrolidone and polyethylene oxide which are typical hydrophilic polymers. One or more intermediate protective layers may be disposed. Pigments such as SiO₂, TiO₂, ZnO₂, CaCO₃, and MgO₂ may be added to the intermediate protective layer in order to enhance surface hardness. An epoxy-based UV cure resin may be combined or mixed to such an extent that there is not any problem in adhesion, compatibility, or wettability with the underlayer protective layer.

In the mode shown in FIG. 2, the intermediate layer 10 is formed directly on the substrate 1 in the hub portion 9, and is formed on the reflective layer in a portion in which the reflective layer 3 is present and on the substrate in a portion in which the reflective layer is not present outside the stack rings.

The printable protective layer 4 writable with an ink jet printer, a thermal transfer printer or the like is formed on the above-described underlayer protective layer, or on the intermediate protective layer if any, at the surface. This printable surface protective layer contains one or more components selected from a hydrophilic polymer, hydrophilic monomer, crosslinking monomer and epoxy-based cationic monomer; one or more components selected from a water absorbing filler and oil absorbing filler; and a radical initiator to be added if necessary.

For the water and/or oil absorbing fillers, an organic and/or inorganic filler is usable. The organic or inorganic filler may be used alone, and may be used in combination in order to improve a drying property after writing, to adjust viscosity of ink for forming the surface protective layer, or to improve color tone. In this case, a combined ratio of both the fillers may be appropriately changed in accordance with the purpose.

Fillers having a thickening function, such as aerosol, may be added to adjust the viscosity of the ink for forming the surface protective layer. Also, various additives are usable in accordance with the purpose. The examples thereof include a leveling or antifoaming agent at a printing time, defoaming agent, thickening agent, anti-dripping agent, anti-settling agent, pigment dispersion auxiliary agent, wetting agent, dispersing agent, and the like.

The examples of the hydrophilic polymer include homopolymers and copolymers such as polyvinyl alcohol, hydroxyethyl cellulose, hydroxypropyl cellulose, polyacrylamido, polyvinyl pyrrolidone, polyethylene oxide and the like. In case of copolymer, a hydrophilic polymer may be used in combination with a non-hydrophilic polymer as long as the copolymer shows characteristics of a hydrophilic polymer. The hydrophilic polymer may be used alone or in combination of two or more.

As the hydrophilic monomer, for example, there may be used a monomer having an OH group in the molecule such as hydroxyethyl(meth)acrylate, hydroxypropyl(meth)acrylate, hydroxybutyl(meth)acrylate, hydroxypentyl(meth)acrylate, phenoxyhydroxypropyl(meth)acrylate, chlorohydroxypropyl(meth)acrylate, diethylene glycol mono(meth)acrylate, triethylene glycol mono(meth)acrylate, polyethylene glycol mono(meth)acrylate, dipropylene glycol mono(meth)acrylate, polypropylene glycol mono(meth)acrylate, glycerin mono(meth)acrylate, glycerin di(meth)acrylate, pentaerythritol tri(meth)acrylate, phenylglycidyl ether(meth)acrylate, dipentaerythritol penta(meth)acrylate, and di(meth)acrylate of bisphenol A epoxy resin; or a monomer having a high polarity, such as dimethyl(meth)acrylamide, diethyl(meth)acrylamide, acroylmorpholine, N-vinyl pyrrolidone, 2-ethoxyethyl(meth)acrylate, 2-methoxyethyl(meth)acrylate, ethylcarbitol(meth)acrylate, and glycidyl(meth)acrylate. A monofunctional or bifunctional or more monomer may be used. Especially when the polymer having a high hydrophilicity is used, if a monomer having a group with a high polarity, such as hydroxyl group, carboxyl group and amino group, in the molecule is used, the hydrophilic polymer is more easily dissolved in the monomer. In order to enhance solubility of the hydrophilic polymer, a solvent, for example, water; alcohols such as methanol, ethanol, propanol, butanol, pentanol, and hexanol; ethers such as dimethyl ether, diethyl ether, methyl ethyl ether, and dipropyl ether; ketones such as acetone and cyclohexanone; and halogen-based solvents such as dichloroethane and chloroform, may be used to dissolve the hydrophilic polymer.

The crosslinking monomer may be added to the ink for forming the surface protective layer. For the crosslinking monomer, trimethylolpropane tri(meth)acrylate, acrylic isocyanurate, 1,4 butanediol di(meth)acrylate 1,6 hexanediol di(meth)acrylate, neopentyl glycol di(meth)acrylate, dicyclopentadienyl di(meth)acrylate, pentaerythritol tetra(meth)acrylate and the like are usable. When the above-described hydrophilic monomer is multifunctional, such as glycerin di(meth)acrylate, pentaerythritol tri(meth)acrylate, and dipentaerythritol hexa(meth)acrylate, any crosslinking monomer may not be added. When the crosslinking monomer is added, a crosslinking density of the protective layer exposed to the surface rises, and coating hardness increases.

A radical initiator may be used in the ink for forming the surface protective layer. The examples of the radical initiator include 1-hydroxycyclohexylphenylketone; 2-hydroxy-2-methyl-1-phenylpropane-1-on; acetophenone-based radical initiators such as 2,2-diethoxy acetophenone and 4′-phenoxy-2,2-dichloro acetophenone; propiophenone-based radical initiators such as 2-hydroxy-2-methyl propiophenone; anthraquinone-based radical initiators such as 2-chloro anthraquinone; and thioxantone-based radical initiators such as 2,4-diethyl thioxantone. In this case, for an adding amount, 0.1 to 10 parts by mass of the radical initiator are mixed with respect to 100 parts by mass of the resin in the ink for forming the surface protective layer. The amount is preferably 1 to 8 parts by mass. One type or two or more types of the radical initiator in combination may be used.

By the use of an ink in which the above-described raw materials are mixed as appropriate, the layer exposed to the surface (outermost layer, or surface protective layer) may be formed.

The examples of a method for forming the intermediate protective layer and/or the surface protective layer include a bar coating method, blade coating method, air knife coating method, roll coating method, and screen printing method. The application of the screen printing method is especially desirable as a simple method. The surface protective layer sometimes contains the above-described organic and/or inorganic filler in the ink, and therefore has a high viscosity, it is difficult to apply the spin coating method, and the screen printing method is generally preferable.

In general, in the silk screen printing, ink (varnish) is charged from above a disc-shaped mesh screen, and the ink is transferred with a squeegee (pressurizing jig for transferring the ink through the screen) to perform the printing. Therefore, the height of a printed outermost surface is uniquely determined by a screen height. Therefore, when the same screen is used to perform the printing, the layer exposed to the outermost surface is formed as the same surface both in a printable region of the recording region and in a printable region of the innermost peripheral hub portion. When the intermediate protective layers are formed in the hub portion and a portion of the outer periphery of the stack ring by the screen printing, levels of the surfaces on which the surface protective layers are formed can be matched with each other, and the thickness of the surface protective layer can be uniformed.

For example, when an image is printed on the surface protective layer by the ink jet method, the thickness of the surface protective layer influences an ink absorbing capability of the surface protective layer. Therefore, when the thickness of the surface protective layer differs between the hub portion and the recording region, a significant difference is sometimes generated in printing quality between these regions. The present inventors have found that when the intermediate layer is disposed in the hub portion, the level of the surface on which the surface protective layer is formed can be adjusted, and the surface protective layer including the hub portion and the recording region can be set to a certain thickness. The intermediate layer is provided with a thickness adjustment function, the thickness can be uniformed in the entire region of the surface protective layer, and the significant difference can be prevented from being made in the printing quality.

In this manner, the surface on which the surface protective layer is formed in the inner peripheral portion is preferably aligned with the surface on which the surface protective layer is formed on the outer peripheral side from the inner peripheral portion by the hydrophobic intermediate layer in the region of the inner peripheral portion in which the surface protective layer is formed. When the intermediate layer is formed in the inner peripheral portion, if the thickness of the layer is set to include the thicknesses of the recording layer, reflective layer and the like formed on the outer peripheral portion, the surfaces on which the surface protective layers of the inner and outer peripheral portions are formed have an equal height from the substrate surface, that is, the same plane.

On the other hand, the spin coating method or the screen printing method may be selected as the method of forming the underlayer protective layer. The underlayer protective layer is directly laminated on the recording layer or the reflective layer, and largely influences recording characteristics, and therefore the spin coating method is preferable in which there is not any influence of pressure application and in which a fine film thickness design by the micron meter is possible.

The film thickness of each of the intermediate protective layer and the surface protective layer may be set to about 1 to 100 μm, and is preferably set to 1 to 20 μm in consideration of the influence on warp of the disk.

In the present invention, at least one of the intermediate layers, which directly contacts the substrate surface in the hub portion, and the surface protective layer are formed to extend to the hub portion in the disk inner periphery. This intermediate layer is set to be hydrophobic in order to enhance the adhesion, compatibility, and wettability with the polycarbonate substrate, and may be formed by coating the acrylic UV cure resin which does not contain the hydrophilic polymer. Furthermore, the surface protective layer is formed on the intermediate layer. In this case, the underlayer intermediate layer has a low hardness, and a monomer component which is not cured by ultraviolet rays contributes to binding and the compatibility with the surface protective layer. Therefore, even when the intermediate layer is hydrophobic, and the surface protective layer includes the hydrophilic group, a sufficient adhesion force can be supposed to be obtained. By the use of the acrylic UV cure resin which does not contain any hydrophilic polymer, the adhesion force of polycarbonate/intermediate layer/surface protective layer is remarkably enhanced, and scratch strength is also enhanced.

The resin layer obtained by applying the acrylic UV cure resin can be cured by UV light. When the resin is cured by the irradiation with the UV light, an energy of 150 to 2000 mJ/cm² may be applied. Preferably 250 to 1000 mJ/cm² is applied. In this case, the coating may be cured in several seconds.

As a UV lamp for use in the curing, a mercury lamp, high-pressure mercury lamp, extra high-pressure mercury lamp, metal halide lamp and the like are used, and the high-pressure mercury lamp and metal halide lamp are desirable considering from a generated energy or lamp price.

At least one of the intermediate layers constituted in this manner, and the protective layer exposed to the surface are printed to the hub portion of the disk, and it is possible to perform writing data in a protective layer portion exposed to the surface with the ink jet printer using an oil-based or aqueous ink, a dye-sublimation printer, or the thermal transfer type printer in the whole area of the printed layer including the hub potion.

The present invention will be described hereinafter with reference to examples, but the present invention is not restricted by these examples.

In an optical information recording medium in which the printable coating layer is formed extending to the disk hub portion with the ink jet printer or the thermal transfer printer, it is general to observe a layer configuration of each layer by sectional SEM or to conduct a pencil hardness test, scratch test or the like in order to confirm the enhancement of the adhesion in the hub portion. Here, the scratch test was used in order to measure the adhesion strength of each layer.

For a scratch tester, a commercially available device is used, and for a pressurizing needle, a diamond needle is used. A load weight is successively pressurized by 5 g, and tracing is performed with the pressurizing needle from an outer peripheral radius r=59 mm to an inner peripheral radius r=11 mm of the disk surface. The adhesion was defined and measured as the load weight until the underlayer protective layer was scratched and rubbed, and the polycarbonate substrate surface was exposed.

In general, the scratch strength is required to be set to such an extent that the layer is not easily peeled even when scratched with nails, and with the diamond needle, a load weight=45 g or more, preferably 55 g or more is considered to be satisfactory. If the scratch strength is not more than this value, there is a possibility that the surface protective layer is rubbed by the nail or finger and is easily peeled.

### EXAMPLE 1

0.5 g of a phthalocyanine dyestuff (manufactured by Tokyo Kasei Kogyo Co., Ltd.) was dissolved in 10 ml of n-octane to prepare a coating solution. An injection-molded substrate formed of polycarbonate (outer diameter of 120 mm, thickness of 1.2 mm) including a spiral groove having a track pitch of 1.6 μm, groove width of 0.6 μm, and groove depth of 0.17 μm was spin-coated with this solution at a rotation number of 1500 rpm to form a recording layer. A range for forming a dyestuff film was set to extend to an outermost periphery from an outer peripheral side of a concave portion in order to avoid the concave portion (stack ring) which is a trace of a mold retaining ring.

Next, silver was formed into a film having a thickness of 60 nm on the recording layer by a sputtering method to obtain a reflective layer.

Further on the substrate on which this reflective layer was formed, an ultraviolet cure resin ink for screen printing “OP-MAT (manufactured by Dainichiseika Colour & Chemicals Mfg. Co., Ltd.)” consisting of an acrylic UV cure resin which did not contain any hydrophilic polymer with an ink viscosity adjusted to 150 poise (P) was screen-printed in a portion in which the underlayer protective layer was to be formed in the outer periphery from the stack ring and a hub portion (inner diameter of 17 mm to 34 mm) using a printing plate having a 350 mesh coarseness. At this time, the surface of a coating film was adjusted so as to have a height of about 15 μm with respect to the substrate surface in printing. Thereafter, the surface was irradiated with the UV by an 80 W 2-lamp UV irradiation device (set so as to transport a medium at a belt speed of 5 m/min) and cured to form the underlayer protective layer.

10 parts by mass of polyvinyl pyrrolidone-vinyl acetate copolymer (7:3, 50 mass % ethanol solution, manufactured by Tokyo Kasei Kogyo Co., Ltd.) as a hydrophilic polymer; 80 parts by mass of acroylmorpholine as a hydrophilic monomer; 5 parts by mass of trimethyrol propane triacrylate as a crosslinking monomer; 5 parts by mass of the radical initiator “Darocua 1173 (2-hydroxy-2-methyl-1-phenyl-propane-1-on, manufactured by Dainippon Ink & Chemicals, Inc.); 15 parts by mass of protein filler (manufactured by Idemitsu Petrochemical Co., Ltd.); 5 parts by mass of synthesized silica “TOKUSILGU (manufactured by Tokuyama Corp., average particle diameter of about 20 μm)”; and a viscosity modifier Aerosil (manufactured by Nippon Aerosil Co., Ltd.) were mixed to manufacture an ink jet-compatible ultraviolet cure resin ink. On the substrate on which the underlayer protective layer was formed, in the same manner as in the underlayer protective layer, this ultraviolet cure resin ink was screen-printed in the portion in which the underlayer protective layer was formed in the outer periphery from the stack ring and in a portion of the hub portion (inner diameter of 17 mm to 34 mm) in which an intermediate layer (underlayer protective layer) was formed, using a printing plate having the 350 mesh coarseness. At this time, the surface of the coating film was adjusted so as to have a height of about 10 μm from the surface of the formed intermediate layer (underlayer protective layer) in printing. Thereafter, the surface was irradiated with the UV by the 80 W 2-lamp UV irradiation device (set so as to transport the medium at a belt speed of 5 m/min) and cured to form a surface protective layer. A portion of the surface protective layer having a film thickness of 10 μm also contained synthesized silica having an average particle diameter of about 20 μm. A convex portion was formed on the surface of the surface protective layer by the synthesized silica, that is, the surface of the surface protective layer includes concave/convex portions, and accordingly an ink absorbing capability improves.

For this printed surface (surface protective layer), characters were printed directly on this resin layer with a commercially available ink jet printer. It was possible to clearly print the characters both on a commonly printable portion in the outer periphery from the stack ring and the hub portion (inner diameter of 17 mm to 34 mm) without being blurred. As a result of measurement of a scratch strength of the hub portion, the strength was 55 g. On the other hand, troubles such as peeling by a nail were not confirmed in the hub portion.

### EXAMPLE 2

0.5 g of a phthalocyanine dyestuff (manufactured by Tokyo Kasei Kogyo Co., Ltd.) was dissolved in 10 ml of n-octane to prepare a coating solution. An injection-molded substrate formed of polycarbonate (outer diameter of 120 mm, thickness of 1.2 mm) including a spiral groove having a track pitch of 1.6 μm, groove width of 0.6 μm, and groove depth of 0.17 μm was spin-coated with this solution at a rotation number of 1500 rpm to form a recording layer. A range for forming a dyestuff film was set to extend to an outermost periphery (radius of 58 mm) from a region (radius of 20 mm) defined by Orange Book on an outer peripheral side of a concave portion in order to avoid the concave portion (stack ring) which is a trace of a mold retaining ring.

Next, silver was formed into a film having a thickness of 60 nm on the recording layer by a sputtering method to obtain a reflective layer.

Further on the substrate on which this reflective layer was formed, an outer portion from the stack ring was spin-coated with an ultraviolet cure resin “SD-1700 (manufactured by Dainippon Ink & Chemicals, Inc.)”, thereafter irradiated with an ultraviolet ray, and cured to form an underlayer protective layer having a thickness of 3 μm.

Further on the layer, an ultraviolet cure resin ink for screen printing “F27 (manufactured by Dainippon Ink & Chemicals, Inc.)” consisting of an acrylic UV cure resin which did not contain any hydrophilic polymer with the ink viscosity adjusted to 150 P was screen-printed in a portion in which the underlayer protective layer was formed in the outer periphery from the stack ring and a hub portion (inner diameter of 17 mm to 34 mm) using a printing plate having a 350 mesh coarseness. At this time, the surface of a coating film was adjusted so as to have a height of about 15 μm with respect to the substrate surface in printing. Thereafter, the surface was irradiated with the UV by an 80 W 2-lamp UV irradiation device (set so as to transport a medium at a belt speed of 5 m/min) and cured to form an intermediate protective layer.

10 parts by mass of polyvinyl pyrrolidone-vinyl acetate copolymer (7:3, 50 mass % ethanol solution, manufactured by Tokyo Kasei Kogyo Co., Ltd.) as a hydrophilic polymer; 80 parts by mass of acroylmorpholine as a hydrophilic monomer; 5 parts by mass of trimethyrol propane triacrylate as a crosslinking monomer; 5 parts by mass of the radical initiator “Darocua 1173 (2-hydroxy-2-methyl-1-phenyl-propane-1-on, manufactured by Dainippon Ink & Chemicals, Inc.); 15 parts by mass of protein filler (manufactured by Idemitsu Petrochemical Co., Ltd.); 5 parts by mass of synthesized silica “TOKUSILGU (manufactured by Tokuyama Corp., average particle diameter of about 20 μm)”; and a viscosity modifier Aerosil (manufactured by Nippon Aerosil Co., Ltd.) were mixed to manufacture an ink jet-compatible ultraviolet cure resin ink. On the substrate on which the intermediate protective layer was formed, in the same manner as in the intermediate protective layer, this ultraviolet cure resin ink was screen-printed in the portion in which the intermediate protective layer was printed in the outer periphery from the stack ring and in a portion of the hub portion (inner diameter of 17 mm to 34 mm) in which the intermediate protective layer was formed, using a printing plate having a 350 mesh coarseness. At this time, the surface of the coating film was adjusted so as to have a height of about 10 μm from the surface of the formed intermediate protective layer in printing. Thereafter, the surface was irradiated with the UV by an 80 W 2-lamp UV irradiation device (set so as to transport a medium at a belt speed of 5 m/min) and cured to form a surface protective layer.

For this printed surface, characters were printed directly on this resin layer with a commercially available ink jet printer. It was possible to clearly print the characters both on the commonly printable portion in the outer periphery from the stack ring and the hub portion (inner diameter of 17 mm to 34 mm) without being blurred. As a result of measurement of a scratch strength of the hub portion, the strength was 130 g, and it was seen that the portion had a sufficient scratch strength. Troubles such as peeling by a nail were not confirmed in the hub portion.

### EXAMPLE 3

After forming a recording layer and reflective layer in the same manner as in Example 2, an outer portion from a stack ring was spin-coated with an ultraviolet cure resin “SD-1700 (manufactured by Dainippon Ink & Chemicals, Inc.)”, thereafter irradiated with an ultraviolet ray with a 80 W 2-lamp UV cure device, and cured to form an underlayer protective layer having a thickness of 3 μm in the same manner as in Example 1.

Further on the layer, an ultraviolet cure resin ink for screen printing “OP-MAT GOLD (manufactured by Dainichiseika Colour & Chemicals Mfg. Co., Ltd.)” consisting of an acrylic UV cure resin which did not contain any hydrophilic polymer with the ink viscosity adjusted to 200 P was screen-printed in a portion in which the underlayer protective layer was formed in the outer periphery from the stack ring and a hub portion (inner diameter of 17 mm to 34 mm) using a printing plate having a 350 mesh coarseness. At this time, the surface of a coating film was adjusted so as to have a height of about 15 μm with respect to the substrate surface in printing. Thereafter, the surface was irradiated with the UV by an 80 W 2-lamp UV irradiation device (set so as to transport a medium at a belt speed of 5 m/min) and cured to form an intermediate protective layer.

Further on the layer, an ink jet-compatible ultraviolet cure resin ink containing a hydrophilic polymer, hydrophilic monomer, and crosslinking monomer “SP-10129 (manufactured by Teikoku Printing Inks Mfg. Co., Ltd.)” was screen-printed in a portion in which the intermediate protective layer was formed in the outer periphery from the stack ring and in a portion of the hub portion (inner diameter of 17 mm to 34 mm) in which the intermediate protective layer was formed using the printing plate having a 350 mesh coarseness in the same manner as in the intermediate protective layer. At this time, the surface of the coating film was adjusted so as to have a height of about 15 μm with respect to the formed intermediate protective layer in printing. Thereafter, the surface was irradiated with the UV by the 80 W 2-lamp UV irradiation device (set so as to transport the medium at a belt speed of 5 m/min) and cured to form the surface protective layer.

For this printed surface, characters were printed directly on this resin layer with a commercially available ink jet printer. It was possible to clearly print the characters both on a commonly printable portion in the outer periphery from the stack ring and the hub portion (inner diameter of 17 mm to 34 mm) without being blurred. As a result of measurement of a scratch strength of the hub portion, the strength was 60 g, and troubles such as peeling by a nail were not confirmed in the hub portion.

### EXAMPLE 4

0.5 g of a cyanine dyestuff (manufactured by Tokyo Kasei Kogyo Co., Ltd.) was dissolved in 10 ml of isopropyl alcohol to prepare a coating solution. An injection-molded substrate formed of polycarbonate (outer diameter of 120 mm, thickness of 1.2 mm) including a spiral groove having a track pitch of 1.6 μm, groove width of 0.6 μm, and groove depth of 0.15 μm was spin-coated with this solution at a rotation number of 1300 rpm to form a recording layer. A range for forming a dyestuff film was set to extend to an outermost periphery (radius of 58 mm) from a range (radius of 20 mm) defined in Orange Book on the outer peripheral side of a concave portion in order to avoid the concave portion (stack ring) which is a trace of a mold retaining ring.

Thereafter, after forming a reflective layer in the same manner as in Example 2, on the reflective layer, an outer portion from the stack ring was spin-coated with an ultraviolet cure resin “SD-1700 (manufactured by Dainippon Ink & Chemicals, Inc.)”, thereafter irradiated with an ultraviolet ray, and cured to form an underlayer protective layer having a thickness of 3 μm.

As acrylic UV cure resin containing no hydrophilic polymer, 10 parts by mass of urethane acrylate oligomer; 60 parts by mass of hydroxyethyl acrylate (manufactured by BASF Japan Ltd.); and 25 parts by mass of 1,4-butandioldiacrylate (manufactured by BASF Japan Ltd.), and 5 parts by mass of the radical initiator “Darocua 1173 (manufactured by Dainippon Ink & Chemicals, Inc.) were mixed, and thereafter a viscosity was adjusted to 100 P. This mixture was used as an ink, and screen-printed in a portion in which the underlayer protective layer was formed in the outer periphery from the stack ring and a hub portion (inner diameter of 17 mm to 34 mm) using a printing plate having a 350 mesh coarseness. At this time, the surface of the coating film was adjusted so as to have a height of about 10 μm with respect to the substrate surface in printing. This coating was cured by an 80 W 2-lamp UV irradiation device (set so as to transport the medium at a belt speed of 5 m/min) to form an intermediate protective layer.

Further on the layer, “Dubuit Labo 6189 (manufactured by Dubuit Co.) which was a thermal transfer-compatible ultraviolet cure resin ink was screen-printed in a portion in which the intermediate protective layer was formed in the outer periphery from the stack ring and in a portion of the hub portion (inner diameter of 17 mm to 34 mm) in which the intermediate protective layer was formed using a printing plate having a 350 mesh coarseness. At this time, the surface of the coating film was adjusted so as to have a height of about 12 μm from the surface of the formed intermediate protective layer in printing. Thereafter, the surface was irradiated with the UV by the 80 W 2-lamp UV irradiation device (set so as to transport the medium at a belt speed of 5 m/min) and cured to form a surface protective layer.

For this printed surface, characters were printed directly on this resin layer with a commercially available thermal transfer printer. It was possible to very clearly print the characters both on a commonly printable portion in the outer periphery from the stack ring and the hub portion (inner diameter of 17 mm to 34 mm) without any thin spot or peeling by a transfer defect. As a result of measurement of a scratch strength of the hub portion, the strength was 100 g, and it was seen that the portion had a sufficient scratch strength. Troubles such as peeling by a nail were not confirmed in the hub portion.

### COMPARATIVE EXAMPLE 1

After forming a recording layer and reflective layer in the same manner as in Example 2, on the reflective layer, an outer portion from a stack ring was spin-coated with an ultraviolet cure resin “SD-1700 (manufactured by Dainippon Ink & Chemicals, Inc.)”, thereafter irradiated with an ultraviolet ray, and cured to form an underlayer protective layer having a thickness of 3 μm. The underlayer protective layer was not laminated in the hub portion.

10 parts by mass of polyvinyl pyrrolidone-vinyl acetate copolymer (7:3, 50 mass % ethanol solution, manufactured by Tokyo Kasei Kogyo Co., Ltd.) as a hydrophilic polymer; 80 parts by mass of acroylmorpholine as a hydrophilic monomer; 5 parts by mass of trimethyrol propane triacrylate as a crosslinking monomer; 5 parts by mass of a radical initiator “Darocua 1173 (manufactured by Dainippon Ink & Chemicals, Inc.); 15 parts by mass of protein filler (manufactured by Idemitsu Petrochemical Co., Ltd.); 5 parts by mass of synthesized silica “TOKUSILGU (manufactured by Tokuyama Corp., average particle diameter of about 20 μm)”; and a viscosity modifier Aerosil (manufactured by Nippon Aerosil Co., Ltd.) were mixed to manufacture an ink jet-compatible ultraviolet cure resin ink. On the substrate on which the underlayer protective layer was formed, this ultraviolet cure resin ink was screen-printed in a portion in which the underlayer protective layer was formed in the outer periphery from the stack ring and the hub portion (inner diameter of 17 mm to 34 mm) using a printing plate having a 350 mesh coarseness to form a surface protective layer. Then, the portion in which the surface protective layer was formed in the outer periphery from the stack ring was printed in a film thickness of about 10 μm with respect to the substrate surface without any problem. On the other hand, the hub portion (inner diameter of 17 mm to 34 mm) repelled the mixed resin ink containing the hydrophilic polymer, and it was not possible to form a satisfactory coating film. Thereafter, the surface was irradiated with the UV by a UV irradiation device and forcibly cured, but the surface protective layer of the hub portion was easily peeled with a nail, and the layer was not capable of bearing its practical use.

### COMPARATIVE EXAMPLE 2

After forming a recording layer and reflective layer in the same manner as in Example 2, on the reflective layer, an outer portion from a stack ring was spin-coated with an ultraviolet cure resin “SD-1700 (manufactured by Dainippon Ink & Chemicals, Inc.)”, thereafter irradiated with an ultraviolet ray and cured to form an underlayer protective layer having a thickness of 3 μm. The underlayer protective layer was not laminated in the hub portion.

Further on the layer, an ink jet-compatible ultraviolet cure resin ink containing a hydrophilic polymer, hydrophilic monomer, and crosslinking monomer “SP-10129 (manufactured by Teikoku Printing Inks Mfg. Co., Ltd.)” was screen-printed in a portion in which the underlayer protective layer was formed in the outer periphery from the stack ring and a hub portion (inner diameter of 17 mm to 34 mm) using a printing plate having a 350 mesh coarseness. At this time, the surface of a coating film was adjusted so as to have a height of about 15 μm with respect to the substrate surface in printing. Thereafter, the surface was irradiated with the UV by an 80 W 2-lamp UV irradiation device (set so as to transport a medium at a belt speed of 5 m/min) and cured to form a surface protective layer.

For this printed surface, characters were printed directly on this resin layer with a commercially available ink jet printer. It was possible to print the characters both on a portion in which the underlayer protective layer and surface protective layer were formed in the outer periphery from the stack ring and the hub portion (inner diameter of 17 mm to 34 mm) without being blurred. As a result of measurement of a scratch strength of the hub portion, the strength was 45 g. A commonly printable portion in the outer periphery from the stack ring was not peeled even when rubbed with a nail, but a peeling trouble was easily caused in the hub portion rubbed with the nail.

### COMPARATIVE EXAMPLE 3

After forming a recording layer and reflective layer in the same manner as in Example 3, on the reflective layer, an outer portion from a stack ring was spin-coated with an ultraviolet cure resin “SD-1700 (manufactured by Dainippon Ink & Chemicals, Inc.)”, thereafter irradiated with an ultraviolet ray and cured to form an underlayer protective layer having a thickness of 3 μm. The underlayer protective layer was not laminated in the hub portion.

Directly on the layer, as a thermal transfer-compatible ultraviolet cure resin ink, “Dubuit Labo 6189 (manufactured by Dubuit Co.) was screen-printed in a portion in which the underlayer protective layer was formed in the outer periphery from the stack ring and the hub portion (inner diameter of 17 mm to 34 mm) using the printing plate having the 350 mesh coarseness. At this time, the surface of a coating film was adjusted so as to have a height of about 12 μm with respect to the substrate surface in printing. Thereafter, the surface was irradiated with the UV by an 80 W 2-lamp UV irradiation device (set so as to transport a medium at a belt speed of 5 m/min) and cured to form a surface protective layer. For this printed surface, characters were printed directly on this resin layer with a commercially available thermal transfer printer. Then, a portion in which the underlayer protective layer and surface protective layer were formed in the outer periphery from the stack ring was printed without any problem. On the other hand, in the hub portion (inner diameter of 17 mm to 34 mm), peeling occurred between the polycarbonate substrate and the surface protective layer, and transfer defect was induced. As a result of measurement of a scratch strength of a place (hub portion) in which the printing partially remained without being peeled, the strength was 30 g, and it was seen that the portion did not have a sufficient scratch strength. The trouble of peeling by a nail easily occurred in the hub portion.

### COMPARATIVE EXAMPLE 4

After forming a recording layer and reflective layer in the same manner as in Example 2, on the reflective layer, an outer portion from a stack ring was spin-coated with an ultraviolet cure resin “SD-1700 (manufactured by Dainippon Ink & Chemicals, Inc.)”, thereafter irradiated with an ultraviolet ray and cured to form an underlayer protective layer having a thickness of 3 μm. The underlayer protective layer was not laminated in the hub portion.

Further on the layer, an ultraviolet cure resin ink containing a hydrophilic polymer “SP-10129 (manufactured by Teikoku Printing Inks Mfg. Co., Ltd.)” was screen-printed in a portion in which the underlayer protective layer was formed in the outer periphery from the stack ring and a hub portion (inner diameter of 17 mm to 34 mm) using a printing plate having a 350 mesh coarseness to coat two layers, and an intermediate protective layer and surface protective layer were formed. During the forming of the intermediate protective layer, the surface of the coating film was adjusted so as to have a height of about 15 μm with respect to the substrate surface. During the forming of the surface protective layer, the surface of the coating was adjusted so as to have a height of about 15 μm with respect to the intermediate protective layer surface. For UV curing, the respective surfaces were irradiated with the UV by an 80 W 2-lamp UV irradiation device (set so as to transport a medium at a belt speed of 5 m/min) and cured.

For this printed surface, characters were printed directly on this resin layer with a commercially available ink jet printer. It was possible to print the characters both on a portion in which the intermediate protective layer and surface protective layer were formed in the outer periphery from the stack ring and a portion of the hub portion (inner diameter of 17 mm to 34 mm) in which the intermediate protective layer and surface protective layer were formed without being blurred. However, as a result of measurement of a scratch strength of the hub portion, the strength was 50 g although two layers were coated. A commonly printable portion of the outer periphery from the stack ring was not peeled even when rubbed with a nail, but the peeling trouble was caused in the hub portion when rubbed with the nail.

### EXAMPLE 5

A single-plate optical disk constituted as shown in FIG. 3 was prepared. This optical disk is suitable, for example, for a CD-R.

In a region of an outer periphery from a groove of a transparent substrate 1 in which an annular groove 5 was formed so as to surround a center hole, a recording layer 2 formed of a phthalocyanine dyestuff, a reflective layer 3 containing silver as a main component, and an underlayer protective layer 10 formed of an acrylic ultraviolet cure resin were formed in this order. The underlayer protective layer was formed by a spin coating method.

Thereafter, an innermost peripheral portion 9 between the groove 5 and the center hole was coated with an ultraviolet cure resin ink for screen printing “OP-MAT” manufactured by Dainichiseika Colour & Chemicals Mfg. Co., Ltd. by silk screen printing to form an intermediate layer 12.

Subsequently, in the innermost peripheral portion 9, and in a region in the outer periphery from the groove 5 including the recording region 7 in which the recording layer was formed, using the same screen, a surface protective layer 4, which was a printable layer formed of an ink jet printable ink containing a hydrophilic polymer, “SP-10129” manufactured by Teikoku Printing Inks Mfg. Co., Ltd., , was formed by the silk screen printing.

Here, the thickness of the intermediate layer 12 was adjusted so that the surface heights and the film thicknesses of the printable layers of the innermost peripheral portion and recording portion were substantially equal. Accordingly, an adhesion force between the substrate and the printable layer in the innermost peripheral portion is strengthened. Also, an absorbing capability of the printable layer can be kept to be substantially constant both in the innermost peripheral portion and the recording region, and smoothness of the outermost surface is kept. Therefore, there is an effect that the ink jet printing having no color unevenness and having uniform contrast can be formed substantially over the whole surface of the optical recording medium. The groove formed in the substrate was formed by a stamper retainer at a molding time of the substrate.

### EXAMPLE 6

A single-plate optical disk constituted as shown in FIG. 4 was prepared. This optical disk is suitable, for example, for a CD-R.

In a region of an outer periphery from a groove of a substrate in which an annular groove 5 was formed so as to surround a center hole, a recording layer 2 formed of a phthalocyanine dyestuff, a reflective layer 3 containing silver as a main component, and an underlayer protective layer 10 formed of an acrylic ultraviolet cure resin were formed in this order. The underlayer protective layer was formed by a spin coating method.

Thereafter, an innermost peripheral portion 9 between the groove 5 and the center hole was coated with an ultraviolet cure resin ink for screen printing “OP-MAT” manufactured by Dainichiseika Colour & Chemicals Mfg. Co., Ltd. by silk screen printing to form an intermediate layer 12.

Subsequently, in the innermost peripheral portion 9, and the region in the outer periphery from the groove 5 including the recording region 7 in which the recording layer was formed, using the same screen, an intermediate layer 13 formed of an ultraviolet cure resin ink for the screen printing “F27” manufactured by Dainippon Ink & Chemicals, Inc. was formed.

Further on the layer, a surface protective layer 4 which was a printable layer formed of an ink jet printable ink “SP-10129” manufactured by Teikoku Printing Inks Mfg. Co., Ltd., containing a hydrophilic polymer, was formed by the silk screen printing. The groove 5 formed in the substrate was formed by a stamper retainer at a molding time of the substrate.

### EXAMPLE 7

A single-plate optical disk constituted as shown in FIG. 5 was prepared. This optical disk is suitable, for example, for a CD-R.

In a region of an outer periphery from a groove of a substrate in which an annular groove 5 was formed so as to surround a center hole, a recording layer 2 formed of a phthalocyanine dyestuff, a reflective layer 3 containing silver as a main component, and an underlayer protective layer 10 formed of an acrylic ultraviolet cure resin were formed in this order. The underlayer protective layer was formed by a spin coating method.

Thereafter, the innermost peripheral portion 9 between the groove 5 and the center hole, and the region present in the outer periphery from the groove 5 including a recording region 7 in which a recording layer was formed were coated with an ultraviolet cure resin ink for screen printing “F27” manufactured by Dainippon Ink & Chemicals, Inc. using the same screen to form an intermediate layer 13.

Subsequently, a surface protective layer 4 which was a printable layer formed of a thermal transfer printable ink “SP-00515” manufactured by Teikoku Printing Inks Mfg. Co., Ltd. was formed in the innermost peripheral portion 9 and the region present in the outer periphery from the groove 5 including the recording region 7 in which the recording layer was formed using the same screen by silk screen printing. The groove 5 formed in the substrate was formed by a stamper retainer at a molding time of the substrate.

### EXAMPLE 8

A recording layer was formed on a substrate, and another substrate was further bonded thereon to form an optical recording medium constituted as shown in FIG. 6. This optical recording medium is suitable, for example, for a DVD-R.

On a first substrate 1 having a thickness of 0.6 mm, a recording layer 2 formed of an azo dyestuff, a reflective layer 3 containing silver as a main component, and an underlayer protective layer 10 formed of an acrylic ultraviolet cure resin were formed in this order. The underlayer protective layer was formed by a spin coating method.

On the layer, a second substrate 20 formed of polycarbonate in the same manner as in the first substrate was bonded with a radical polymerization type adhesive.

Subsequently, the surface of the second substrate was coated with an ultraviolet cure resin ink for screen printing “F27” manufactured by Dainippon Ink & Chemicals, Inc. by silk screen printing, and cured to form an intermediate layer 13.

Further on the layer, a surface protective layer 4 which was a printable layer formed of an ink jet printable ink containing a hydrophilic polymer, “SP-10129” manufactured by Teikoku Printing Inks Mfg. Co., Ltd., was formed by the silk screen printing.

A stack ring 5 for reducing a contact portion when the substrates were stacked at a manufacturing time was formed in the second substrate. The intermediate layer 13 and surface protective layer 4 were both formed in an innermost peripheral portion 9 inside the stack ring and an outer region including a recording region 7 using the same screen by the silk screen printing.

### EXAMPLE 9

An optical recording medium constituted as shown in FIG. 7 was prepared. This optical recording medium is suitable, for example, for a DVD-R.

In the same manner as in Example 8, a second substrate 20 was bonded onto a first substrate 1 on which a recording layer 2, reflective layer 3, and underlayer protective layer 10 were formed. However, here, a substrate having no concave/convex portion was used as the second substrate.

Thereafter, an intermediate layer 13 was formed on the whole surface of the second substrate using an ultraviolet cure resin ink for spin coating “SD1700” manufactured by Dainippon Ink & Chemicals, Inc., and further on the layer, a surface protective layer 4 which was a printable layer formed of a thermal transfer printable ink “SP-10730” manufactured by Teikoku Printing Inks Mfg. Co., Ltd. was formed. The intermediate layer 13 and the surface protective layer 4 were formed by spin-coating the respective inks, and curing with the ultraviolet ray.

### EXAMPLE 10

An optical recording medium constituted as shown in FIG. 8 was prepared. This optical recording medium is suitable, for example, for a DVD-R.

In the same manner as in Example 8, a second substrate 20 having a stack ring 5 was bonded onto a first substrate 1 on which a recording layer 2, reflective layer 3, and underlayer protective layer 10 were formed.

Thereafter, an intermediate layer 13 was formed on the surface of the second substrate using an ultraviolet cure resin ink for screen printing “F27” manufactured by Dainippon Ink & Chemicals, Inc., and further on the layer, a surface protective layer 4 which was a printable layer formed of an ink jet printable ink containing a hydrophilic polymer, “SP-10129” manufactured by Teikoku Printing Inks Mfg. Co., Ltd., was formed by silk screen printing.

The stack ring 5 for reducing a contact portion when the substrates were stacked at a manufacturing time was formed in the second substrate. The intermediate layer 13 was formed in a printed film thickness which was not less than the height of the stack ring, and thus both the intermediate layer 13 and the surface protective layer 4 were formed on the whole surface by the silk screen printing both inside and outside the stack ring 5.

### EXAMPLE 11

An optical disk constituted as shown in FIG. 9 was prepared. The present example is similar to Example 6 shown in FIG. 4 except that formed positions of an intermediate layer 13 and surface protective layer 4 differ.

In the constitution of the present example, the whole inner peripheral portion is covered with an intermediate layer 12, but an intermediate layer 13 and surface protective layer 4 are disposed only in a part of the inner peripheral portion.

### EXAMPLE 12

An optical recording medium constituted as shown in FIG. 10 was prepared. The present example is similar to Example 8 shown in FIG. 6 except that formed positions of an intermediate layer 13 and surface protective layer 4 differ.

In the constitution of the present example, a whole inner peripheral portion is covered with an intermediate layer 12, but the intermediate layer 13 and surface protective layer 4 are disposed only in a part of the inner peripheral portion.

In the modes shown in FIGS. 9 and 10, the intermediate layer and the surface protective layer are preferably formed in positions apart from an end of the central hole of the transparent substrate by 2 mm or more from the following view points. The intermediate layer and surface protective layer are preferably formed by the screen printing. In this case, a center pole (not shown) is inserted in the central hole of the transparent substrate for positioning. Then a screen having mesh is laid on the substrate, and an ink for forming the intermediate layer or the surface protective layer is applied, and flatted with a squeegee. If there is a distance of 2 mm or more between the center pole and the mesh, a load onto the screen is reduced during the ink is flatted with the squeegee, and a life of the screen increases. Furthermore, the ink can also be prevented from sagging in the central hole of the substrate owing to the above-described distance of 2 mm or more.

### INDUSTRIAL APPLICABILITY

As described above, according to the present invention, an optical recording medium can be manufactured in which an image is printable clearly without being repelled or thinned to an inner peripheral portion or a hub portion with an ink jet printer and/or a thermal transfer printer without deteriorating scratch strength. Moreover, by the use of an intermediate protective layer which does not contain any hydrophilic polymer, it is possible to improve repelling or low strength of a surface protective layer caused by low wettability between a polycarbonate substrate and the surface protective layer including the hydrophilic polymer in the hub portion.

1. An optical recording medium comprising a recording layer, one or more intermediate layers, and a printable or typable surface protective layer disposed in this order on a transparent substrate having an annular plate shape,
said optical recording medium having an inner peripheral portion in which the recording layer is not formed on an inner peripheral side in a radial direction of the transparent substrate,
wherein the surface protective layer is formed in at least a part of the inner peripheral portion, and
a hydrophobic intermediate layer is directly formed on the transparent substrate in a region of the inner peripheral portion in which the surface protective layer is formed.

2. The optical recording medium according to claim 1, wherein a protrusion or a groove concentric to the transparent substrate is formed on the transparent substrate, a recording region in which the recording layer and the surface protective layer are formed is disposed on an outer peripheral side from the protrusion or the groove, and
the recording layer is not formed and the surface protective layer is formed on an inner peripheral side from the protrusion or the groove.

3. An optical recording medium comprising a recording layer, a second transparent substrate having an annular plate shape, one or more intermediate layers, and a printable or typable surface protective layer disposed in this order on a first transparent substrate having an annular plate shape,
said optical recording medium having an inner peripheral portion in which the recording layer is not formed on an inner peripheral side in a radial direction of the second transparent substrate,
wherein the surface protective layer is formed in at least a part of the inner peripheral portion, and
a hydrophobic intermediate layer is directly formed on the transparent substrate in a region of the inner peripheral portion in which the surface protective layer is formed.

4. The optical recording medium according to claim 3, wherein a protrusion or a groove concentric to the second transparent substrate is formed on the second transparent substrate, a recording region in which the recording layer and the surface protective layer are formed is disposed on an outer peripheral side from the protrusion or the groove, and
the recording layer is not formed and the surface protective layer is formed on an inner peripheral side from the protrusion or the groove.

5. The optical recording medium according to claim 4, wherein the hydrophobic intermediate layer is formed of an acrylic UV cure resin which does not contain a hydrophilic polymer.

6. The optical recording medium according to claim 4, wherein the hydrophobic intermediate layer is formed by silk screen printing.

7. The optical recording medium according to claim 4, wherein a surface on which the surface protective layer is formed in the inner peripheral portion is aligned with a surface on which the surface protective layer is formed on an outer peripheral side from the inner peripheral portion by the hydrophobic intermediate layer present in a region of the inner peripheral portion in which the surface protective layer is formed.

8. The optical recording medium according to claim 1, wherein the hydrophobic intermediate layer is formed of an acrylic UV cure resin which does not contain a hydrophilic polymer.

9. The optical recording medium according to claim 2, wherein the hydrophobic intermediate layer is formed of an acrylic UV cure resin which does not contain a hydrophilic polymer.

10. The optical recording medium according to claim 3, wherein the hydrophobic intermediate layer is formed of an acrylic UV cure resin which does not contain a hydrophilic polymer.

11. The optical recording medium according to claim 1, wherein the hydrophobic intermediate layer is formed by silk screen printing.

12. The optical recording medium according to claim 2, wherein the hydrophobic intermediate layer is formed by silk screen printing.

13. The optical recording medium according to claim 3, wherein the hydrophobic intermediate layer is formed by silk screen printing.

14. The optical recording medium according to claim 1, wherein a surface on which the surface protective layer is formed in the inner peripheral portion is aligned with a surface on which the surface protective layer is formed on an outer peripheral side from the inner peripheral portion by the hydrophobic intermediate layer present in a region of the inner peripheral portion in which the surface protective layer is formed.

15. The optical recording medium according to claim 2, wherein a surface on which the surface protective layer is formed in the inner peripheral portion is aligned with a surface on which the surface protective layer is formed on an outer peripheral side from the inner peripheral portion by the hydrophobic intermediate layer present in a region of the inner peripheral portion in which the surface protective layer is formed.

16. The optical recording medium according to claim 3, wherein a surface on which the surface protective layer is formed in the inner peripheral portion is aligned with a surface on which the surface protective layer is formed on an outer peripheral side from the inner peripheral portion by the hydrophobic intermediate layer present in a region of the inner peripheral portion in which the surface protective layer is formed.
